(19) United States
(12) Patent Application Publication
(10) Pub. No.: US 2004/0210387 A1
(43) Pub. Date: Oct. 21, 2004

(54) Method for operating a navigation system for a vehicle

(76) Inventors: Arne Friedrichs, Braunschweig (DE); Gerd Draeger, Braunschweig (DE); Volker Skwarek, Bad Salzdetfurth (DE)

Correspondence Address: Striker Striker & Stenby, 103 East Neck Road, Huntington, NY, 11743, US

(21) Appl. No.: 10/474,092

(22) PCT Filed: Feb. 13, 2002
(86) PCT No.: PCT/DE02/00501

(30) Foreign Application Priority Data
Apr. 6, 2001 (DE) 101 17 395.4

(51) Int. Cl. G01C 21/30

(52) U.S. Cl. 701/209; 340/995.12

(57) ABSTRACT

The present invention relates to a method for operating a navigation system (10) for a vehicle, in particular for a motor vehicle, according to which a positioning system (14) determines data on the geographical position of the vehicle and transmits said data to an electronic data processing system (12) with access to a database (16, 18) and a digital road map. Said data is used to determine the location of the vehicle on the digital road map, and directions to the destination are acoustically and/or visually output to the driver of the vehicle. The invention also relates to a navigation system having means for carrying out the method.

The invention provides that a current distance (d) of the vehicle from a first decision point (R₁) on a route to be taken by the vehicle is permanently verified, and, when the vehicle exceeds a minimum distance (dₘᵢₙ) after passing the decision point (R₁), a next decision point (A₁) is established.

### TECHNICAL AREA

The present invention relates to a method for operating a navigation system for a vehicle, in particular for a motor vehicle, according to which a positioning system determines data on the geographical position of the vehicle and transmits said data to an electronic data processing system with access to a database and a digital road map and, using said data, determines the location of the vehicle on the digital road map, and directions to the destination are acoustically and/or visually output to the driver of the vehicle.

### BACKGROUND INFORMATION

Navigation systems for vehicles, in particular motor vehicles, and methods for operating navigation systems of this type are known. Said systems and methods serve to determine the current geographical position of the vehicle and, depending on a predeterminable destination point to be reached, to calculate the most favorable route and give the driver directions for traveling said route.

The known navigation systems require information that is needed to determine the current location of the vehicle and calculate the route to be driven. Said information includes, in particular, street layouts, conditions for turning off, and the like. Said data is stored in the form of a data base on storage media, such as a CD-ROM, in the vehicle. The data base includes, e.g., a “digital map” for this purpose, said digital map containing the route markers and/or decision points along the possible routes.

Furthermore, a positioning system that determines the current geographical position of the vehicle is required. The Global Positioning System (GPS), which utilizes satellites, is known for this application, for example. An electronic data processing system processes the position data delivered by the positioning system with the data stored in the digital road map and determines the current position of the vehicle. In accordance with the selected destination point, directions to the destination can now be acoustically and/or visually output to the driver of the vehicle by the electronic data processing system based on path points and/or decision points along a selected, most favorable driving route.

These methods, known as “map-matching” methods, for operating a navigation system compare information from various sensors for determining the position of the vehicle (e.g., using GPS), the direction in which the vehicle is being driven (e.g., using a gyro compass), and the speed at which the vehicle is being driven (e.g., using speed sensors) with the information in the stored digital map. Since the information from the sensors usually contains measuring errors, said information is compared with the information on position and direction contained in the digital map, and it is corrected. To correct the sensors, therefore, contents of a digital map having the highest possible resolution (fine geometry or shape points) are required.

If, however, digital maps are used, for instance, that do not contain any or only a portion of said fine geometry information, the known methods for operating a navigation system cannot be used. Digital maps without fine geometry information are used in “off-board navigation systems”, with regard to which the pertinent information is transmitted from a service center via a transmission path to the vehicles. Since the available transmission rates are limited, the data are reduced to a necessary minimum. It is known that, in the case of said off-board navigation systems, the decision points along a most-favorable driving route can be transmitted to the vehicles.

### ADVANTAGES OF THE INVENTION

The present invention is based on the object of improving a method for operating a navigation system for a vehicle, in particular a motor vehicle, and navigation system.

This object is attained by the measures and features stated in claims 1 and 10.

The method, according to the invention, for operating a navigation system having the features stated in claim 1 offers the advantage that time-critical directions to the destination can be output to a driver of a vehicle based on less information from a digital map and less position information about the vehicle. Due to the fact that a current distance of the vehicle from a first decision point on a route to be taken by the vehicle is permanently verified and, when the vehicle exceeds a minimum distance after passing the first decision point, a next decision point is established, it advantageously becomes possible to combine sensor information from a positioning system with the information from a digital map—that is, with the decision points from the digital map—with each other in such a manner that it is possible to obtain exact directions to the destination and simultaneously verify the route to be taken. In particular, due to the fact that the method is based on distance verifications, in particular on changes of a distance from decision points, it becomes possible to process the data in simple fashion, so that the navigation system as a whole can be operated at low expense.

A preferred embodiment of the invention provides that the distance information received and/or the information received about the change of a distance from decision points are used to verify that a predetermined, most favorable driving route is still being followed. As a result, it becomes possible, advantageously, to output additional information to the driver of the vehicle, informing him that he has left the most favorable route to reach the destination point he specified. Furthermore, this also makes it possible, advantageously, to determine a new, most favorable driving route, based on a route change entered by the driver of the vehicle, and to use said change as the basis for establishing further directions to the destination.

The navigation system according to the invention having the features stated in claim 8 offers the advantage that said navigation system has a simple design, yet is still capable of outputting time-critical directions to the destination.

Further preferred embodiments of the invention result from the remaining features stated in the dependent claims.

### BRIEF DESCRIPTION OF THE DRAWING

The invention is described in greater detail herein below in an exemplary embodiment with reference to the associated drawing.

FIG. 1 is a block diagram of the navigation system according to the invention;

FIG. 2 is a section of a driving route, and

FIG. 3 is a block diagram of the method for operating a navigation system.

### DETAILED DESCRIPTION OF THE EMBODIMENT

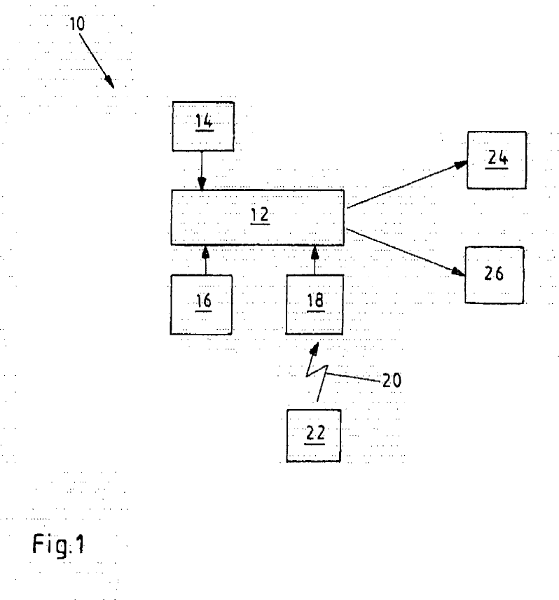

FIG. 1 is a schematic illustration of a navigation system, labelled as a whole with reference numeral 10, for a motor vehicle. Navigation system 10 includes an electronic data processing system 12 that can include not-shown microprocessors, memory elements or the like. Navigation system 10 further includes a positioning system 14, e.g., a Global Positioning System (GPS) that is known per se. A mass storage device 16, e.g., a CD-ROM, and/or a receiving device 18 is associated with system 12. Receiving device 18 communicates via a transmission path 20 with a higher-order, stationary service center 22. A digital road map can be transmitted to system 12 via mass storage device 16 and/or receiving device 18. Depending on the embodiment, navigation system 10 can include mass storage device 16 and receiving device 18 or only mass storage device 16 or receiving device 18. The furnishing of digital road maps to navigation system 10 is generally known, so it shall not be discussed in greater detail within the framework of the description.

Navigation system 10 further includes a visual output device 24, e.g., a display or the like, and/or an acoustic output device 26, e.g., a loudspeaker or the like.

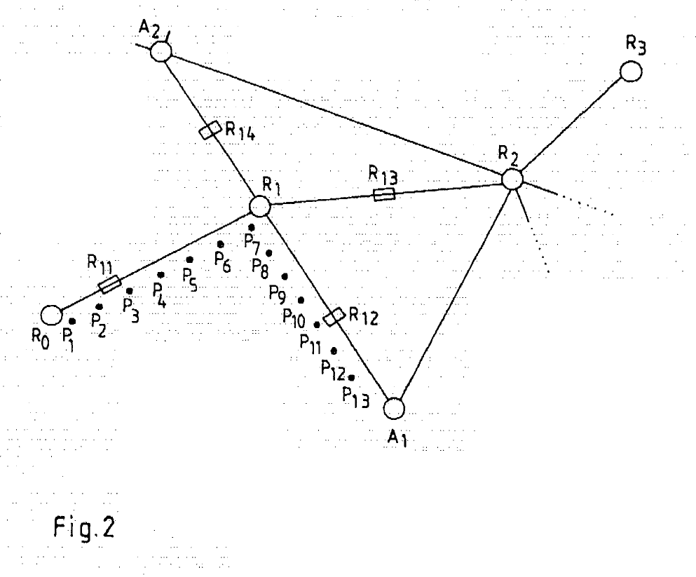

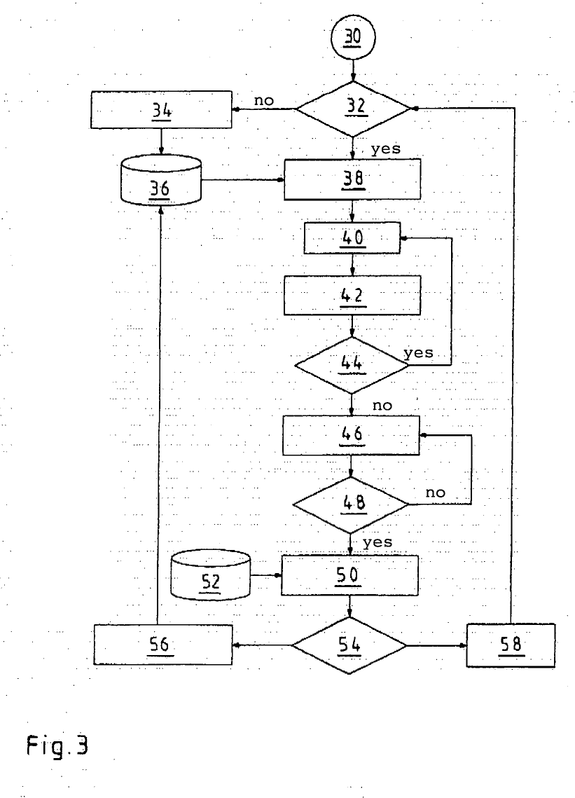

The method according to the invention for operating navigation system 10 is illustrated herein below with reference to FIGS. 2 and 3.

FIG. 2 shows the section of a route for a vehicle. It is assumed that a vehicle would like to travel from path point R₀ to its final destination (destination point), path point R₃. The most favorable driving route that results is the route over path points R₁ and R₂ to R₃. This information is supplied to navigation system 10, either via mass storage device 16 or higher-order data system 22 and receiving device 18. At the same time, navigation system 10 receives information about further path points adjacent to the most favorable route that can be taken, as alternate path points A₁ and A₂, for reaching the planned final destination R₃ (route corridor). Path points R₁, R₂ and A₁ and A₂ are each decision points at which the driving direction can be changed if the driver makes a turn, for instance. Auxiliary path points are defined around each path point; examples include auxiliary path points R₁₁, R₁₂, R₁₃ and R₁₄ as shown, that are associated with path point R. Said auxiliary path points are not decision points.

It is now assumed that the vehicle is traveling away from path point R₀ and is approaching path point R₁. As it travels, the vehicle passes position points P₁, P₂, P₃, P₄, P₅, P₆ and P₇. Position points P correspond to the current positions of the vehicle as determined by positioning system 14.

As the vehicle approaches path point R₁, the method illustrated in the block diagram in FIG. 3 is carried out. Starting at Start 30, a query 32 begins that asks if the next path point to be reached (path point R₁ in the example) is known. If the next path point R₁ is not known, a search 34 takes place. The result of said search is identification 36 of the next path point. If the next path point R₁ is known, or if it is identified, a determination 38 of the current distance (referred to as distance d herein below) of the vehicle to the next path point R₁ is carried out. Assuming, in the example, that the vehicle is located at position point P₄, the current distance from path point R1 is d_{P4}. This current distance is stored for the interim in step 40 as dₘᵢₙ. As the vehicle continues to approach path point R₁, the next position point to be passed is P₅. At position point P₅, the distance from path point R₁ is determined anew in step 42. A query 44 is then run to determine if the new distance d_{P5} is less than distance dmin stored for the interim in step 40. If the new distance d_{P5} is less, it is stored for the interim as the new value dₘᵢₙ. As the vehicle approaches path point R₁, query 44 is repeated at each of the position points until, at position point P₇, the distance dₘᵢₙ from path point R₁ can no longer be less.

According to a first aspect of the invention, this determination and/or verification of the approach of the vehicle to path point R₁ can be used to visually and/or acoustically output directions to the driver in timely fashion, i.e., just before path point R₁ is reached. For example, at position points P₅ and/or P₆ and/or P₇, the driver can be instructed to drive straight ahead at path point R₁, in accordance with the most favorable route, that is being taken.

If the driver of the vehicle does not follow these directions and turns in the direction of alternate path point A₁—as shown in the example—the vehicle passes position points P₈, P₉, P₁₀, P₁₁, P₁₂, P₁₃ in sequence. According to query 44, a determination is made at each position point as to whether the current distance d to path point R₁ is less than or greater than the distance dₘᵢₙ stored previously for the interim. As the vehicle travels away from path point R₁, e.g., when it passes position point P₈, the current distance d to path point R₁ becomes greater, since the minimum possible distance at position point P₇—which coincides with path point R₁—is given. After this, the current distance d to path point R₁—which is now increasing—is determined in step 46. In a subsequent query 48, the current distance d is compared with a distance threshold e_{F}. If the current distance d is less than the distance threshold e_{F}, the current distance d to path point R₁ when the next particular position point—position points P₉, P₁₀, P₁₁ in the example—is passed is newly determined each time (step 46), and query 48 is started anew each time. It is assumed that the distance threshold e_{F} corresponds to the distance d of position point P₁₂ and, therefore, to auxiliary path point R₁₂ of path point R₁.

If the distance threshold e_{F} is reached, e.g., at position point P₁₂, the driving direction is checked in the next step 50. Since the simple fact that the distance from path point R₁ is increasing is still not a criterium for determining the driving direction (distance d to distance threshold e_{F} increases even if the vehicle travels in the direction of path point R₂ and/or alternate path point A₂), the direction in which the vehicle is travelling is determined using the direction information provided by directional sensors, e.g., GPS or a gyro compass. In this process, path points R₀, R₂, A₁ and A₂ that are adjacent to path point R₁ are pulled from an intermediate memory 52, and a query 54 is run to determine which of them has the smallest directional distance from the path points adjacent to path point R₁. This path point—path point A₁ in the example—is established, in a selection step 56, as the next path point (step 36), so that, when the vehicle approaches the now new path point A₁, the method according to the invention for operating the navigation system 10 starts over anew.

If query 54 reveals that the next path point is not located in the previously selected route corridor—as defined by the driver of the vehicle having entered destination point R₃—mass storage device 16 or, in the case of off-board systems, higher-order service center 22 is queried in step 58 as to whether the next path point is known. The routine then starts anew with query 32.

Based on the explanation with reference to the example, it becomes clear that, using information from a positioning system and information from a digital map—whereby the digital map need only contain the decision points on a route, for example—said information can be so combined that acoustic and/or optical directions to the destination can be output in time-critical fashion. Furthermore, after a decision point is passed (as indicated by path point R₁, for example), the next decision point can be determined. The next decision point need not be the one that is specified according to a most favorable route to take. Said information can be used to output directions to a destination, and the knowledge of which driving direction has been taken after a decision point has been passed can serve to determine the accuracy of the route actually being taken. Deviations from the predetermined most-favorable driving route are therefore possible. This knowledge can be used either to provide the driver of the vehicle with appropriate information, or, depending on the actual deviation from the most favorable driving route, it can be used to determine a new, most favorable driving route.

The method according to the invention is particularly suited for operating a navigation system in “off-board navigation systems”, since, in said systems, the determined, most favorable route or partial route is established in a service center and transmitted to the vehicle and/or the navigation system 10. These digital maps or routes are known for the fact that they are described with very little data information, which means that transmission capacities and, therefore, transmission costs, can be reduced. Finally, the reduced amounts of data information—which contain, for example, the decision points along the route and the possible directions to the destination at the particular decision points—are adequate.

What is claimed is:

1. A method for operating a navigation system (10) for a vehicle, in particular for a motor vehicle, according to which a positioning system (14) determines data on the geographical position of the vehicle and transmits said data to an electronic data processing system (12) with access to a database (16, 18) and a digital road map and, using said data, determines the location of the vehicle on the digital road map, and directions to the destination are acoustically and/or visually output to the driver of the vehicle,
wherein a current distance (d) of the vehicle from a first decision point (R₁) on a route to be taken by the vehicle is permanently verified, and, when the vehicle exceeds a minimum distance (dₘᵢₙ) after passing the decision point (R₁), a next decision point (A₁) is established.

2. The method as recited in claim 1, wherein the minimum distance (dₘᵢₙ) to be exceeded is defined by a distance threshold (e_{F}).

3. The method as recited in claim 1, wherein the distance threshold (e_{F}) is determined by defined auxiliary path points (R₁₂) around a decision point (R₁).

4. The method as recited in claim 1, wherein, when the distance threshold (e_{F}) is reached, the direction of travel is checked.

5. The method as recited in claim 1, wherein a distance threshold (e_{F}) can vary according to vehicle speed or other vehicle state variables (e.g., acceleration).

6. The method as recited in claim 4, wherein a smallest directional difference between the position point that is being approached and that represents the distance threshold (e_{F}) and the path points (R₀, R₂, A₁, A₂) adjacent to the decision point (R₁) is determined.

7. The method as recited in claim 5, wherein the path point having the smallest directional difference is established as the next decision point (A₁).

8. The method as recited in claim 1, wherein the path point having the shortest distance from the vehicle is established as the next decision point.

9. The method as recited in claim 1, wherein, when a predeterminable minimum distance (dₘᵢₙ) to the next decision point (R₁) is reached, the directions to the destination are output.

10. A navigation system (10) for a vehicle, in particular a motor vehicle, comprising a positioning system (14), an electronic data processing system (12), a database (16, 18) that comprises a digital road map, and at least one output system (24, 26) for outputting directions to the destination, characterized by means for determining a current distance to a decision point (R₁) on a route,
by means for comparing the current distance with a minimum distance (dₘᵢₙ), and by means for establishing a new decision point (A₁) on the route when the minimum distance (dₘᵢₙ) is exceeded.
